(19) United States
(12) Patent Application Publication
(10) Pub. No.: US 2024/0406258 A1
(43) Pub. Date: Dec. 5, 2024

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: TAKAYUKI SUZUKI, Kanagawa (JP)

(21) Appl. No.: 18/663,191

(22) Filed: May 14, 2024

(30) Foreign Application Priority Data
Jun. 1, 2023 (JP) 2023-090787

(51) Int. Cl. H04L 67/1074; G06F 3/12

(52) U.S. Cl. CPC H04L 67/1085; G06F 3/1205; G06F 3/1243

(57) ABSTRACT

Provided is a control method of an information processing apparatus, the control method including: downloading information relating to a content of a first category, information relating to a content of a second category, and information relating to a content of a third category to the information processing apparatus in sequence according to a predetermined download order; displaying a plurality of regions including regions corresponding to the content of the first category, the content of the second category, and the content of the third category; and executing, in a case where one of the plurality of regions is selected, display being based on information that relates to a content of a category corresponding to the selected one region and that is already downloaded to the information processing apparatus.

### BACKGROUND

### Field

The present disclosure relates to an information processing apparatus, a control method of an information processing apparatus, and a storage medium.

### Description of the Related Art

There is known a technique of improving responsiveness to contents placed in a server by downloading in advance the contents that are likely to be used. Japanese Patent Laid-Open No. 2011-70583 describes a technique in which obtaining levels of contents are set based on content usage statuses in a terminal, and the contents to be downloaded are downloaded according to the obtaining levels.

### SUMMARY

There is a dem and for a further improvement in usability in downloading of contents.

A control method of an information processing apparatus according to one aspect of the present disclosure includes: downloading information relating to a content of a first category, information relating to a content of a second category, and information relating to a content of a third category to the information processing apparatus in sequence according to a predetermined download order; displaying a plurality of regions including a region corresponding to the content of the first category, a region corresponding to the content of the second category, and a region corresponding to the content of the third being based on information that relates to a content of a category corresponding to the selected one region and that is already downloaded to the information processing apparatus, a place of the information relating to the content of the first category in the predetermined download order is a first place, a place of the information relating to the content of the second category in the predetermined download order is a second place that is after the first place, and a place of the information relating to the content of the third category in the predetermined download order is a third place that is after the first place and the second place, in a case where the region corresponding to the content of the third category is selected in a state where the information relating to the content of the first category is being downloaded and downloading of the information relating to the content of the second category and the information relating to the content of the third category is not completed yet, control is performed such that the downloading of the information relating to the content of the third category is executed before the downloading of the information relating to the content of the second category, and in a case where the region corresponding to the content of the third category is not selected in the state where the information relating to the content of the first category is being downloaded and the downloading of the information relating to the content of the second category and the information relating to the content of the third category is not completed yet, control is performed such that the downloading of the information relating to the content of the second category is executed before the downloading of the information relating to the content of the third category.

Further features of the present invention will become apparent from the following description of exemplary embodiments with reference to the attached drawings.

### BRIEF DESCRIPTION OF THE DRAWINGS

FIG. 1 is a diagram illustrating a configuration of a system;

FIG. 2 is a block diagram illustrating a configuration of an information processing apparatus;

FIG. 3 is a block diagram illustrating a configuration of a printing apparatus;

FIG. 4 is a block diagram illustrating a configuration of a server;

FIG. 5 is a diagram illustrating a home screen of the information processing apparatus;

FIG. 6 is a diagram illustrating a top screen of a printing application;

FIG. 7 is a diagram illustrating a content selection screen;

FIG. 8 is a diagram illustrating a sheet size selection screen;

FIG. 9 is a diagram illustrating an image selection screen;

FIG. 10 is a diagram illustrating an editing screen;

FIG. 11 is a diagram illustrating a print setting screen;

FIG. 12 is a diagram illustrating processing of displaying the content selection screen;

FIG. 13 is a diagram illustrating information included in a content list;

FIG. 14 is a diagram illustrating the content selection screen in a processing-in-progress state;

FIGS. 15A to 15C are diagrams explaining a download order of contents; and

FIG. 16 is a diagram illustrating information included in the content list.

### DESCRIPTION OF THE EMBODIMENTS

Embodiments are explained below in detail with reference to the drawings. Note that the following embodiments do not limit the present disclosure according to the scope of claims, and not all of combinations of features explained in the present embodiment are necessarily essential for solving means of the present disclosure.

Although the following embodiments are explained with a smartphone given as an example of an information processing apparatus, the type of information processing apparatus is not limited to this as long as the information processing apparatus can receive gesture operations performed by an operator with fingers through a touch panel display. For example, various apparatuses such as a mobile terminal other than the smartphone, a laptop personal computer (PC), a desktop PC, a tablet terminal, a personal digital assistant (PDA), or a digital camera can be adopted as the information processing apparatus. Moreover, any printer such as an inkjet printer or a laser beam printer can be used as a printing apparatus. Furthermore, the printing apparatus may be a multi-function peripheral that has not only a print function but also a scan function of reading an original, a copying function, or a facsimile function.

### Embodiment 1

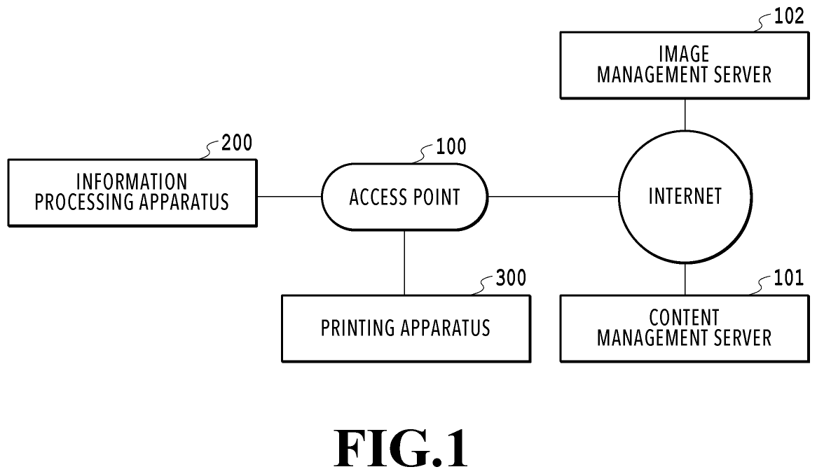

FIG. 1 is a diagram illustrating a configuration of a system in the present embodiment. This system includes an information processing apparatus 200 and a printing apparatus 300. The information processing apparatus 200 is an information processing apparatus that communicates with the printing apparatus 300 via a network built by an access point 100, and causes the printing apparatus 300 to execute printing. Programs such as a printing application program (hereinafter, printing application) to be described later are stored in the information processing apparatus 200. Accordingly, print data created by using this printing application is sent from the information processing apparatus 200 to the printing apparatus 300 via the network. Note that, for example, the printing application is downloaded to the information processing apparatus 200 via the network, and is installed. Alternatively, for example, the printing application may be installed from a storage medium attached to the information processing apparatus 200. Moreover, since the access point 100 of the present embodiment function as a wireless LAN router, the information processing apparatus 200 connects to the Internet via this wireless LAN router. Accordingly, the information processing apparatus 200 can communicate with a content management server 101 via the Internet. Note that, although the printing apparatus 300 is illustrated in FIG. 1, multiple printing apparatuses 300 can be connected to the access point 100.

The content management server 101 is a server that manages contents used by the printing application. An image management server 102 is a server that can save image data captured by a user with a camera. Each of the servers described above is a server system, and may be formed of one server PC or multiple server PCs. In other words, processes executed by each of the servers described above may be executed by multiple server PCs working together, instead of being executed by one server PC.

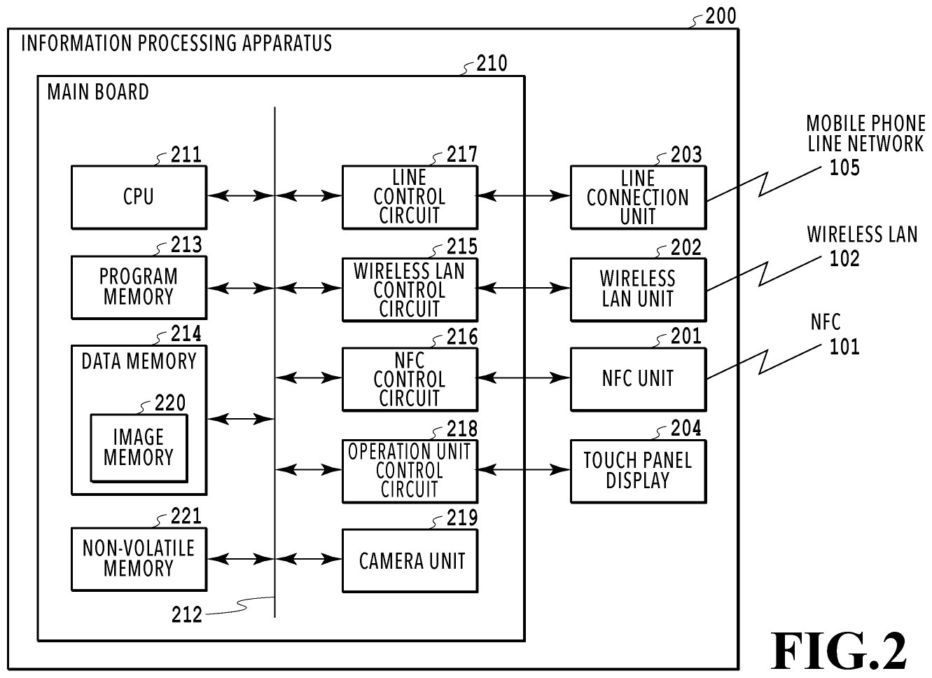

FIG. 2 is a block diagram illustrating a configuration of the information processing apparatus 200 in the present embodiment. The information processing apparatus 200 includes a main board 210 that controls the entire apparatus, a wireless LAN unit 202, an NFC unit 201, a line connection unit 203, and a touch panel display 204 on which function operations of the printer and information on the printer are displayed. The NFC unit 201, the wireless LAN unit 202, and the line connection unit 203 can communicate by using NFC communication, a wireless LAN, and a mobile phone line network, respectively.

A CPU 211 of a microprocessor form arranged in the main board 210 operates according to contents of a data memory 214 of a RAM form and a control program stored in a program memory 213 of a ROM form connected to the CPU 211 via an internal bus 212. The program memory 213 can store an embedded operating system (OS) and programs such as the printing application of the present embodiment. In the present embodiment, software execution control of application programs stored in the program memory 213 is performed under control of the OS. Specifically, the CPU 211 implements the software execution control by loading the application programs stored in the program memory 213 onto the data memory 214 of the RAM form, and executing the application programs.

The CPU 211 performs wireless LAN communication with other apparatuses by controlling the wireless LAN unit 202 via a wireless LAN control circuit 215. Note that the wireless LAN unit 202 is assumed to be capable of performing data (packet) communication by a communication method in compliance with, for example, IEEE 802.11 series (IEEE 802.11a, IEEE 802.11b, IEEE 802.11g, and the like).

Moreover, the CPU 211 can detect NFC connection with other NFC terminals and exchange data with the other NFC terminals by controlling the NFC unit 201 via an NFC control circuit 216. Furthermore, the CPU 211 can connect to the mobile phone line network and perform a phone call or data exchange by controlling the line connection unit 203 via a line control circuit 217. Moreover, the information processing apparatus 200 may include a unit for performing communication by a communication method of Bluetooth (registered trademark) Low Energy (BLE).

The CPU 211 can perform display control of the touch panel display 204, and receive operations from the user by controlling an operation unit control circuit 218. The CPU 211 can capture an image by controlling a camera unit 219, and stores the captured image in an image memory 220 in the data memory 214. Moreover, in addition to the captured image, the CPU 211 can store an image obtained from the outside through the mobile phone line network, the wireless LAN, or the NFC in the image memory 220, or send an image to the outside in the other way around.

A non-volatile memory 221 is formed of a memory such as a flash memory, and stores data that is desired to be saved also after turn-off of power source. For example, phone book data, various types of communication connection information, information on past-connected devices, image data desired to be saved, and the like are stored. Application program management information managed by the printing application of the present embodiment is also stored in the non-volatile memory 221.

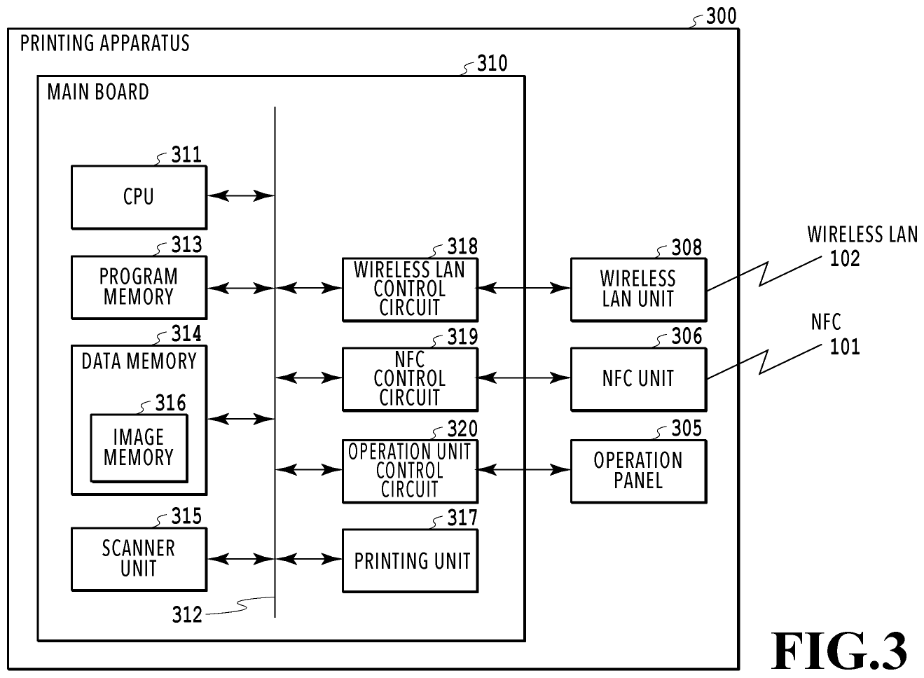

FIG. 3 is a block diagram illustrating a configuration of the printing apparatus 300 in the present embodiment. The printing apparatus 300 includes a main board 310 that controls the entire apparatus, a wireless LAN unit 308, an NFC unit 306, and an operation panel 305. The wireless LAN unit 308 and the NFC unit 306 function as a communication unit of the printing apparatus 300.

A CPU 311 of a microprocessor form arranged in the main board 310 operates according to contents of a data memory 314 of a RAM form and a control program stored in a program memory 313 of a ROM form connected to the CPU 311 via an internal bus 312.

The CPU 311 reads an original by controlling a scanner unit 315, and stores a read image in an image memory 316 in the data memory 314. Moreover, the CPU 311 can print an image in the image memory 316 in the data memory 314 on a printing medium by controlling a printing unit 317. Furthermore, the scanned image data can be sent to the information processing apparatus 200 via the wireless LAN unit 308 controlled by a wireless LAN control circuit 318. Note that, although the printing unit 317 is assumed to perform printing by an inkjet method in the present embodiment, the printing unit 317 is not limited to this form. The printing unit 317 may perform printing by another method such as an electrophotographic method or a thermal sublimation method.

The CPU 311 performs wireless LAN communication with other apparatuses by controlling the wireless LAN unit 308 via the wireless LAN control circuit 318. Note that the wireless LAN unit 308 is assumed to be capable of performing data (packet) communication by a communication method in compliance with, for example, IEEE 802.11 series (IEEE 802.11a, IEEE 802.11b, IEEE 802.11g, and the like). Moreover, the CPU 311 can detect NFC connection with other NFC terminals and exchange data with the other NFC terminals by controlling the NFC unit 306 via an NFC control circuit 319. Note that communication methods of communication executable by the printing apparatus 300 are not limited to the above methods. For example, the printing apparatus 300 may be capable of performing communication by other communication methods such as Bluetooth Classic or Bluetooth Low Energy.

The CPU 311 can display a state of the printing apparatus 300 and function selection menus on the operation panel 305, and receive operations from the user by controlling an operation display unit control circuit 320. Moreover, the printing apparatus of the present embodiment can perform printing by receiving a print job that includes data of JPEG file format and to which a printer control command is given.

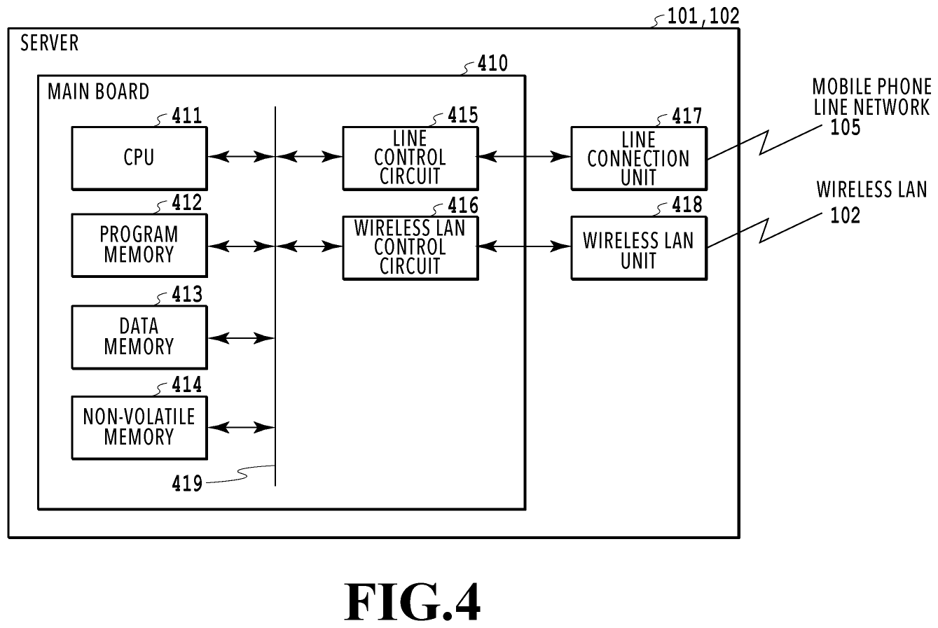

FIG. 4 is a block diagram illustrating a configuration of the content management server 101 and the image management server 102 in the present embodiment. Each server includes a main board 410 that controls the entire apparatus, a wireless LAN unit 418, and a line connection unit 417. The wireless LAN unit 418 and the line connection unit 417 can perform communication by using the wireless LAN and the mobile phone line network, respectively.

A CPU 411 of a microprocessor form arranged in the main board 410 operates according to contents of a data memory 413 of a RAM form and a control program stored in a program memory 412 of a ROM form connected to the CPU 411 via an internal bus 419. The program memory 412 can store programs such as an embedded operating system (OS). In the present embodiment, software execution control of application programs stored in the program memory 412 is performed under control of the OS. Specifically, the CPU 411 implements the software execution control by loading the application programs stored in the program memory 412 onto the data memory 413 of the RAM form, and executing the application programs.

The CPU 411 performs wireless LAN communication with other apparatuses by controlling the wireless LAN unit 418 via a wireless LAN control circuit 416. Note that the wireless LAN unit 418 is assumed to be capable of performing data (packet) communication by a communication method in compliance with, for example, IEEE 802.11 series (IEEE 802.11a, IEEE 802.11b, IEEE 802.11g, and the like). Moreover, the CPU 411 can connect to the mobile phone line network and perform a phone call or data exchange by controlling the line connection unit 417 via a line control circuit 415.

A non-volatile memory 414 is formed of a memory such as a flash memory, and stores data that is desired to be saved also after turn-off of power source. For example, contents are stored in the case of the content management server 101, image data is stored in the case of the image management server 102, and information necessary for notification control to be described later is stored in the case of a notification management server 103. Note that the server configurations of the content management server 101 and the image management server 102 do not have to be exactly the same.

Next, a display screen of the printing application in the present embodiment and operations thereof are explained. The CPU 211 executes the printing application stored in the program memory 213 to display the display screen of the printing application on the touch panel display 204. Note that explanation is given assuming that user interface control of the printing application in the present embodiment is created in a program language that operates in multiple platforms such as HTML5 or JavaScript. However, the program language is not limited to this, and the user interface control may be created in a platform-specific language such as Java or Objective-C.

Note that the CPU 211 loads the program of the printing application and stored in the program memory 213 or the like onto the data memory 214 being the RAM, and executes the program to implement the following processing steps executed in a state where the screen is displayed by the printing application. Note that not all of the following processing steps are necessarily sequentially executed on one process. For example, there may be a case where an entity of the processing steps temporarily transitions to the OS, and the OS invokes the printing application again to cause the printing application to execute subsequent processing steps.

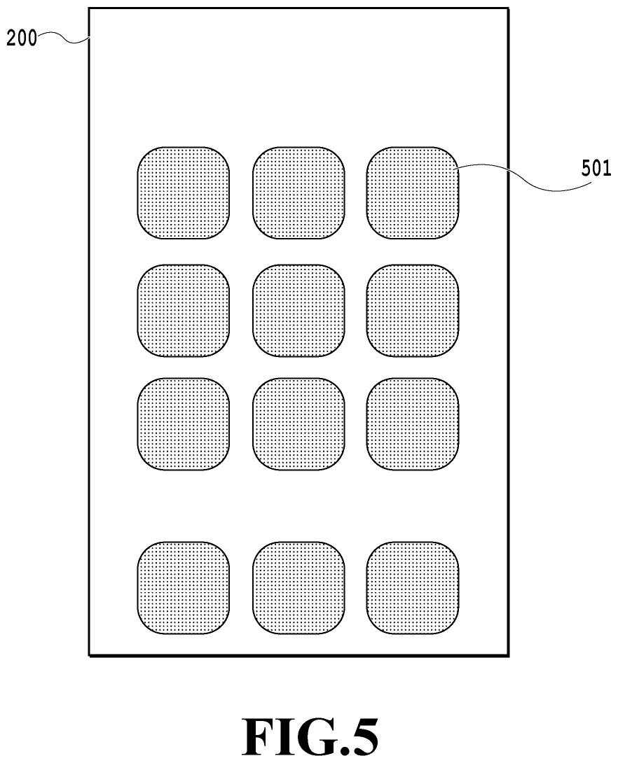

FIG. 5 is a diagram illustrating a home screen in the information processing apparatus 200 in the present embodiment. The home screen is a screen in which the OS or the like displays icons 501 corresponding to the application programs installed in the information processing apparatus 200. Selecting each icon launches the application program corresponding to the selected icon.

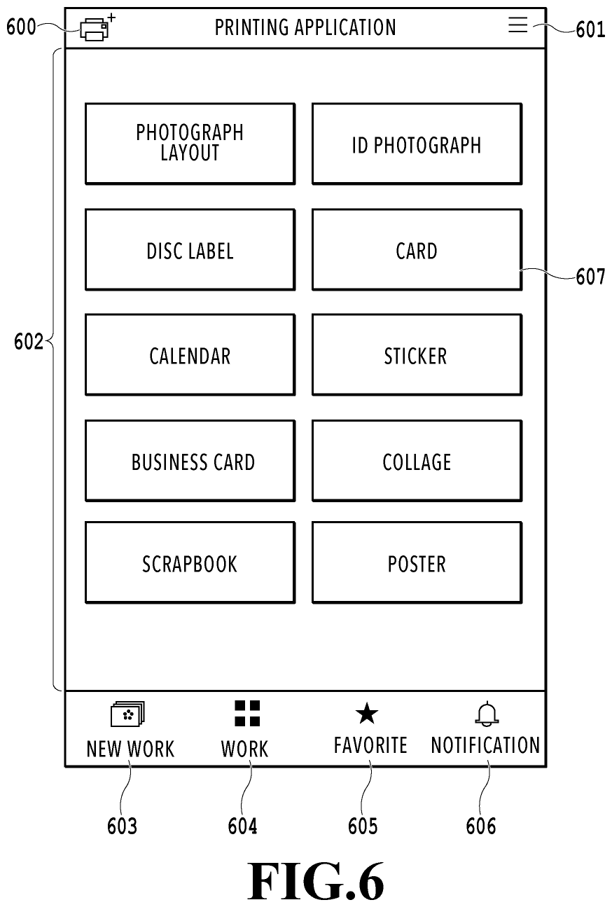

FIG. 6 is a diagram illustrating a top screen of the printing application. A printer registration button 600, a menu button 601, a main display region 602, a new work button 603, a work display button 604, a favorite display button 605, and a notification display button 606 are displayed in the screen illustrated in FIG. 6.

In the case where any of the buttons is tapped, contents according to the tapped button are displayed in the main display region 602. FIG. 6 illustrates a display example of the main display region 602 at launching of the printing application or in the case where the new work button 603 is tapped to create new print data.

In the case where the printer registration button 600 is tapped, a not-illustrated printer registration screen is displayed. A printer to which the print job is to be sent is selected and set through registration processing performed through the printer registration screen. In the case where the menu button 601 is tapped, version information, license information, various pieces of information on the printing application, and the like are displayed.

In the top screen illustrated in FIG. 6, multiple category selection buttons 607 are displayed in the main display region 602. The category selection buttons 607 correspond, respectively, to categories of work printable in the printing application of the present embodiment. Although texts of “calendar”, “card”, and the like are displayed in the category selection buttons 607 in FIG. 6, icons corresponding to the respective categories may be displayed together with these texts. In the case where any of the category selection buttons 607 is tapped, a display target of the touch panel display 204 transitions to a screen for printing a content of a category corresponding to the tapped category selection button 607. Specifically, for example, in the case where the category selection button 607 in which “collage” is written is tapped, the display target of the touch panel display 204 transitions to a screen for creating a collage. Similarly, in the case where the category selection button 607 in which “calendar” is written is tapped, the display target of the touch panel display 204 transitions to a screen for creating a calendar. Note that the content includes design data of a calendar, a card, or the like, information designating the arrangement location and size of an image, print sheet size information, a content name, and the like. The design data is, in other words, a template. Moreover, the template is data for arranging an image selected by the user. For example, the template includes one or multiple slots for arranging images selected by the user. Furthermore, in the template, a background image may be set in advance in a region outside the slots. Moreover, although the content is assumed to be obtained from the content management server 101 in the present embodiment, there may be a content held in advance by the printing application. Furthermore, the content usable in printing or presence or absence of editing functions such as insertion of an image or a text into the content vary depending on the category selection button 607 tapped by the user. The top screen illustrated in FIG. 6 may include a predetermined button for executing a predetermined function that can be executed without content information downloaded from the content management server 101. The predetermined function is specifically, for example, a function of printing an image held by the information processing apparatus 200 or an image uploaded on a cloud service or a social networking service (SNS) without arranging the image on a template. Note that, in the case where the predetermined button is operated, the printing application can execute the predetermined function without waiting for completion of downloading of the later-described content information.

In the present embodiment, buttons for ten types of categories are assumed to be present in the top screen illustrated in FIG. 6. Specifically, buttons for “photograph layout”, “ID photograph”, “disc label”, “card”, “calendar”, “sticker”, “business card”, “collage”, “scrapbook”, and “poster” are assumed to be present. In the present embodiment, varying types of templates correspond to each of the categories, and the templates corresponding to each category are assumed to be downloaded as the content corresponding to each category. The “photograph layout” is a category corresponding to a function of printing a layout created by arranging images selected by the user in a template. Templates corresponding to the “photograph layout” each include one or multiple slots for arranging the images selected by the user. The “photograph layout” is assumed to support multiple sheet sizes as sheet sizes of a print target, and multiple types of templates corresponding to the “photograph layout” are assumed to be present for each sheet size. The “ID photograph” is a category corresponding to a function of printing an ID photograph. Templates corresponding to the “ID photograph” each include multiple slots for arranging the ID photograph selected by the user and cut-here lines. Moreover, the templates corresponding to the “ID photograph” support only a predetermined size for the ID photograph. The “disc label” is a category corresponding to a function of printing a disc label to be attached to a disc-shaped storage medium such as a CD or a DVD. Templates corresponding to the “disc label” each include one or multiple slots for arranging images selected by the user or a printable region corresponding to the shape of the disc. The templates corresponding to the “disc label” support only the predetermined size for the disc label. The “calendar” is a category corresponding to a function of printing a calendar. Templates corresponding to the “calendar” each include one or multiple slots for arranging images selected by the user and a region illustrating dates as a calendar. The templates corresponding to the “calendar” support one or multiple sizes for the calendar. The “card” is a category corresponding to a function of printing a card in which images selected by the user are arranged in a template. Templates corresponding to the “card” each include one or multiple slots for arranging the images selected by the user. The templates corresponding to the “card” support one or multiple sizes for the card. The “sticker” is a category corresponding to a function of printing a sticker in which images selected by the user are arranged in a template. Templates corresponding to the “sticker” each include one or multiple slots for arranging the images selected by the user. The templates corresponding to the “sticker” support one or multiple sizes for the sticker. The “business card” is a category corresponding to a function of printing a business card. Templates corresponding to the “business card each include a slot for arranging a face photograph selected by the user and a region for describing the name and affiliation of the user. The templates corresponding to the “business card” support only the predetermined size for the business card. Note that the templates corresponding to the “business card” may include a template for printing multiple copies of one edited business card on one sheet. The “collage” is a category corresponding to a function of printing a layout image in which images selected by the user are arranged on a template. Templates corresponding to the “collage” each include a background image and one or multiple slots for arranging the images selected by the user. The templates corresponding to the “collage” support one or multiple sizes for the collage. The “scrapbook” is a category corresponding to a function of printing an image of a predetermined pattern or design. Templates corresponding to the “scrapbook” each include no slot for arranging images selected by the user. The templates corresponding to the “scrapbook” support one or multiple sizes for the scrapbook. The “poster” is a category corresponding to a function of printing a poster. Templates corresponding to the “poster” may each include no slot for arranging images selected by the user. The templates corresponding to the “poster” support one or multiple sizes for the poster. Note that a category other than the categories described above may be included in the categories corresponding to the buttons included in the top screen illustrated in FIG. 6. Moreover, not all of the categories described above have to be included in the categories corresponding to the buttons included in the top screen illustrated in FIG. 6.

In the case where the work display button 604 illustrated in FIG. 6 is tapped, a list of thumbnails of pieces of work saved by the user is displayed on the main display region 602 in an icon state. The work saved by the user is print target image data that the user has created by selecting one of the category selection buttons 607. Note that, in this list display, the thumbnails may be displayed with the pieces of work categorized depending on the categories corresponding to the category selection buttons 607.

In the case where the favorite display button 605 is tapped, a screen illustrating a list of contents registered as favorites by the user is displayed on the main display region 602. In the case where the notification display button 606 is tapped, notification information such as an update report of contents is displayed on the main display region 602.

Next, explanation is given of a display example in the case where the category selection buttons 607 are tapped. In the case where one of the category selection buttons 607 is tapped, the display target of the touch panel display 204 transitions to a content selection screen displaying a list of contents corresponding to the selected category.

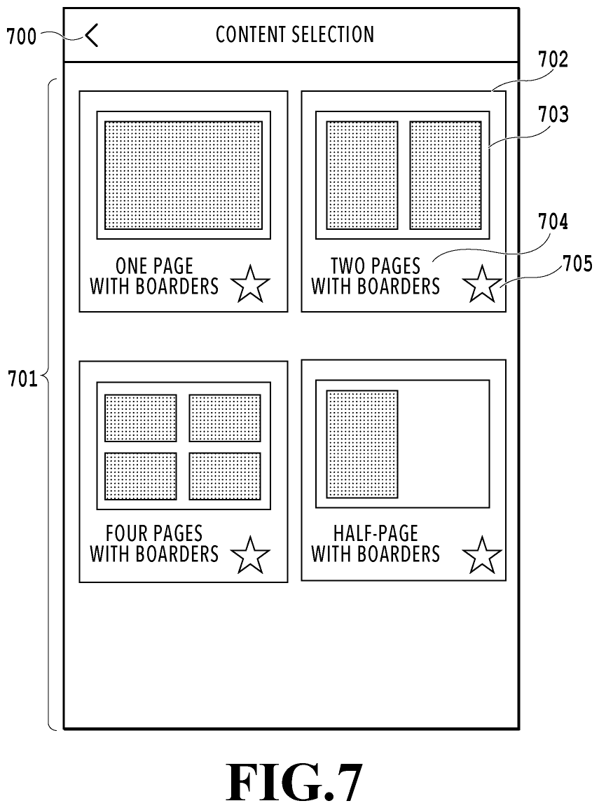

FIG. 7 is a diagram illustrating a content selection screen corresponding to the category “photograph layout”. The content selection screen includes a return button 700 and a content display region 701. In the case where the return button 700 is tapped, the display target of the touch panel display 204 transitions to the screen before transition to the present screen (screen of FIG. 6). Multiple pieces of content information 702 are displayed in the content display region 701. Each piece of content information 702 includes a content thumbnail 703 corresponding to the corresponding category, a content name 704, and a favorite button 705. The content information 702 is a region displayed based on detailed-content information downloaded in download processing to be described later. The detailed-content information is information corresponding to each content, and is information indicating the name of the content, a saved location of a thumbnail image of the content, a saved location of the content, a sheet size supported by the content, and the like. The information indicating the saved location is specifically, for example, URL. In the present embodiment, the detailed-content information and the content itself are assumed to be downloaded at separate timings, respectively. Note that the content thumbnail 703 is displayed based on the thumbnail image downloaded based on the information indicating the saved location of the thumbnail image included in the detailed-content information. In the case where the favorite button 705 is tapped, the corresponding content is registered in favorite. The content registered in favorite is shown in a screen displayed by tapping of the favorite display button 605. In the case where the content information 702 is tapped, the display target of the touch panel display 204 transitions to a sheet size selection screen.

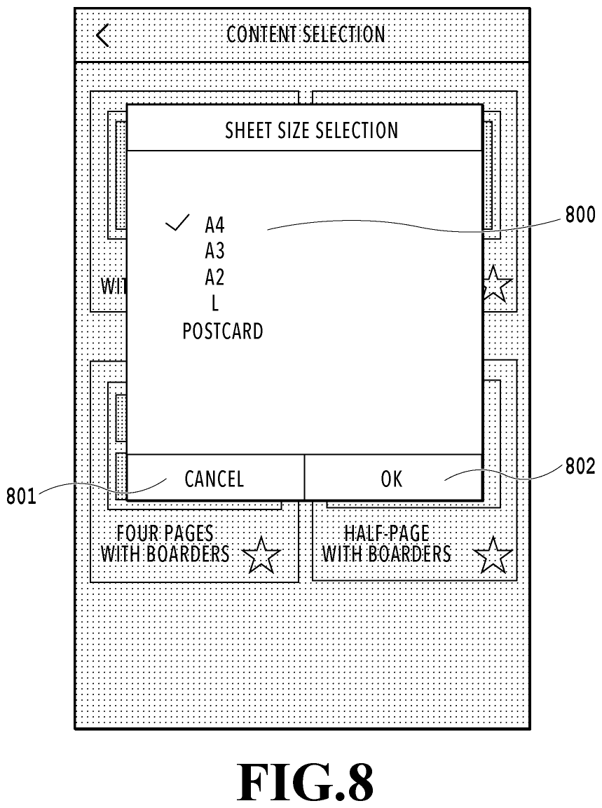

FIG. 8 is a diagram illustrating the sheet size selection screen. The sheet size selection screen includes a sheet size list 800, a cancel button 801, and an OK button 802. The sheet size to be printed can be designated from sheet sizes displayed in the sheet size list 800. In the case where the cancel button 801 is tapped, the display target of the touch panel display 204 transitions to the screen before transition to the present screen (screen of FIG. 7). In the case where the OK button 802 is tapped, the display target of the touch panel display 204 transitions to a corresponding image selection screen. In the present embodiment, in the case where the content selected in the content selection screen is a content held by the content management server 101, the printing application downloads information for printing this content based on the tapping of the OK button 802. The information downloaded in this case includes print setting information that is information on optimal settings in printing and the content itself. Moreover, this downloading is performed based on the information indicating the saved location of the content included in the detailed-content information. Then, the printing application displays an editing screen corresponding to the downloaded content based on the downloaded content. Note that the configuration is not limited to this mode, and the printing application may download the content based on the selection of the content in the content selection screen, before the display of the sheet size selection screen or during the display of the sheet size selection screen. Note that, in the case where the content selected in the content selection screen is a content held by the printing application in advance, the printing application displays the editing screen based on the content held in advance without executing the downloading from the external server.

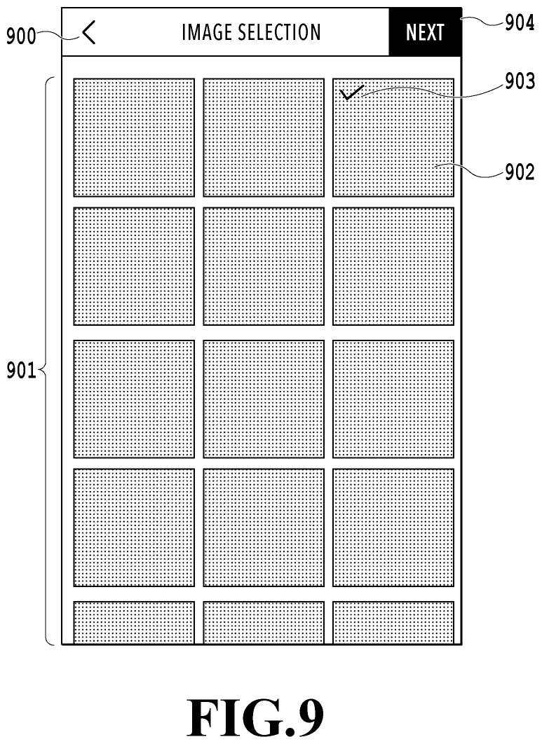

FIG. 9 is a diagram illustrating the image selection screen. The image selection screen includes a return button 900, an image thumbnail display region 901, and a next button 904. In the case where the return button 900 is tapped, the display target of the touch panel display 204 transitions to the content selection screen illustrated in FIG. 7. Images held by the information processing apparatus 200 or images held by the image management server 102 are displayed as thumbnails 902 in the image thumbnail display region 901. Selecting one or more thumbnails 902 allows the images to be combined with the content selected in the content selection screen illustrated in FIG. 7. A selection state icon 903 is displayed in the selected thumbnail 902 to allow determination of a selection state. In the case where the next button 904 is tapped, the display target of the touch panel display 204 transitions to the editing screen.

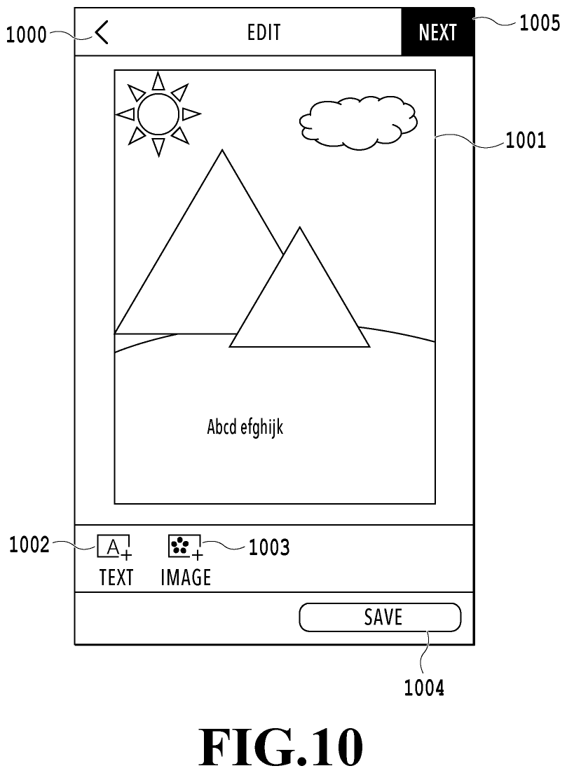

FIG. 10 is a diagram illustrating the editing screen. The editing screen includes a return button 1000, a page editing region 1001, a text button 1002, an image button 1003, a save button 1004, and a next button 1005. In the case where the return button 1000 is tapped, the display target of the touch panel display 204 transitions to the content selection screen illustrated in FIG. 7. The page editing region 1001 illustrates work generated based on the content and image selected by the user.

In the case where the text button 1002 is tapped, a not-illustrated screen for inputting a text is displayed. The text inputted in this screen is arranged in the content corresponding to the editing screen. Note that the position where the text is arranged may be allowed to be set to any position by the user, or may be predetermined for each content. In the case where the image button 1003 is tapped, a screen for selecting an image is displayed. In this screen, for example, the images held by the information processing apparatus 200 and the images held by the image management server 102 are selection targets. In the case where any of the images held by the image management server 102 is selected, the printing application obtains the selected image from the image management server 102. The image selected in this screen is arranged in the content corresponding to the editing screen. Note that the position where the image is arranged may be allowed to be set to any position by the user, or may be predetermined for each content. Moreover, the contents of editing are reflected in the page editing region 1001 as appropriate. In the case where the save button 1004 is tapped, the content corresponding to the currently-displayed page editing region 1001 is saved. In the case where the next button 1005 is tapped, the display target of the touch panel display 204 transitions to a screen for checking print settings.

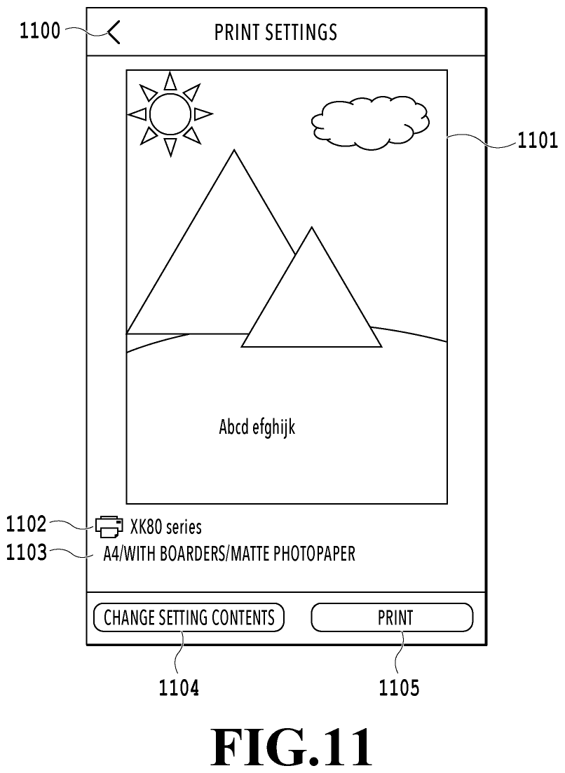

FIG. 11 is a diagram illustrating the screen for checking the print settings. The print setting screen includes a return button 1100, a preview display portion 1101, a registered printer information portion 1102, a print setting display portion 1103, a print setting button 1104, and a print button 1105. In the case where the return button 1100 is tapped, the display target of the touch panel display 204 transitions to the screen before transition to the present screen (screen of FIG. 10). A print preview that is display content similar to the page editing region 1001 and that is based on the content selected by the user and the editing result of this content is displayed in the preview display portion 1101. In the case where the print setting button 1104 is tapped, a not-illustrated print detail setting screen for changing the print settings or a printer to which the print job is to be sent is displayed.

In the print setting screen, for example, the printer to which the print job is to be sent, the number of prints, the type of sheet used in printing, the size of a sheet used in printing, or the like can be set and changed. Information on the printer currently set as the printer to which the print job is to be sent is displayed in the registered printer information portion 1102. The currently-set print settings are displayed in the print setting display portion 1103. In the case where the selected content includes the print setting information, the print settings are updated by using the print setting information, and are displayed in the print setting display portion 1103. Note that, in the case where the printer to which the print job is to be sent or the print settings are changed in the print setting screen, the contents after the change are displayed in the registered printer information portion 1102 and the print setting display portion 1103.

Moreover, the contents displayed in the registered printer information portion 1102 and the print setting display portion 1103 are stored in the program memory 213 or the non-volatile memory 221. Accordingly, in the case where the printing application is terminated and launched again, similar contents are displayed again in the registered printer information portion 1102 and the print setting display portion 1103. There is a case where the screen for checking the print settings is displayed for the first time after the installing of the printing application into the information processing apparatus 200, and the selected content do not include the print setting information. In this case, default settings determined in the printing application are displayed in the registered printer information portion 1102 and the print setting display portion 1103.

In the case where the print button 1105 is tapped, the print job for printing the content selected or edited by the user in FIGS. 7 to 10 are sent to the printing apparatus 300 based on the set print settings. Specifically, first, the CPU 211 executes rendering on the content selected or edited by the user, and converts the content to JPEG data. Moreover, the CPU 211 gives a print control command including the print setting information and the like to the generated JPEG data, and generates the print job. The print job generated as described above is sent to the printing apparatus 300. Note that the display target of the touch panel display 204 transitions to a not-illustrated printing-in-progress screen while the printing job is sent and the printing based on the print job is performed in the printing apparatus 300. In the printing-in-progress screen, a degree of progress of printing based on the print job, the contents of print settings in the sent print job, a region for cancelling the printing based on the print job, or the like is displayed.

Conventionally, there has been used a technique in which, in downloading of the detailed-content information held by the server, responsiveness is improved by downloading the detailed-content information likely to be used in advance. However, the above technique mentions nothing about a method of reducing time it takes to display a content list screen that is a screen indicating what kinds of contents are usable and that is a screen displayed based on the detailed-content information. For example, the detailed-content information for printing includes design data of a calendar, a card, or the like, information for designating the arrangement location and size of an image, print sheet size information, information on a content name, or the like. Since preferences of content users vary, many pieces of detailed-content information need to be prepared. However, a configuration in which the pieces of content information 702 for all categories are displayed all at once in an operation of selecting one content from multiple existing contents has such a problem that display of the content list screen takes time. Instead of displaying the pieces of content information 702 for all categories all at once, a configuration in which a category whose contents are to be displayed is determined depending on selection of the user is desirable.

Accordingly, in the present embodiment, there is considered a technique in which the detailed-content information corresponding to a category selected by the user is preferentially downloaded in the download processing of the pieces of detailed-content information for the respective categories. This allows the content list screen corresponding to the category selected by the user to be displayed as soon as the downloading of the detailed-content information corresponding to the category selected by the user is completed, and an improvement in usability can be expected. A processing flow performed by the printing application of the present embodiment is explained below.

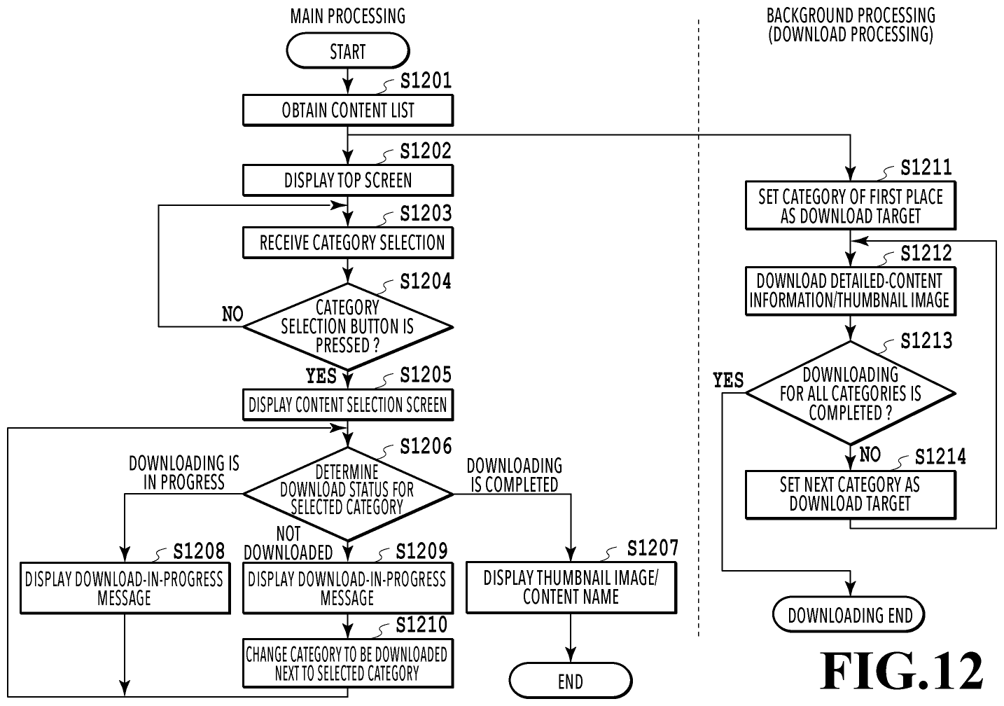

FIG. 12 is a diagram illustrating processing in which the printing application displays the content selection screen. Specifically, the processing of FIG. 12 is processing from the launch of the printing application to the display of, for example, the content selection screen for the category of “photograph layout” as illustrated in FIG. 7 on the touch panel display 204. The CPU 211 loads the program of the printing application stored in the program memory 213, the non-volatile memory 221, or the like onto the data memory 214 being the RAM, and executes the program to implement the present processing. Note that not all of the processing steps illustrated in FIG. 12 are necessarily sequentially executed on one process. For example, there may be a case where an entity of the processing steps temporarily transitions to the OS, and the OS invokes the printing application again to cause the printing application to execute subsequent processing steps. Moreover, the processing of the flowchart illustrated in FIG. 12 is started in response to launching of the printing application by the CPU 211. Although processing performed as main processing by the printing application and processing performed as background processing (download processing) are illustrated in one flowchart in the explanation of FIG. 12, the main processing is explained first.

First, in S1201, the CPU 211 accesses the content management server 101, and obtains a content list from the content management server 101.

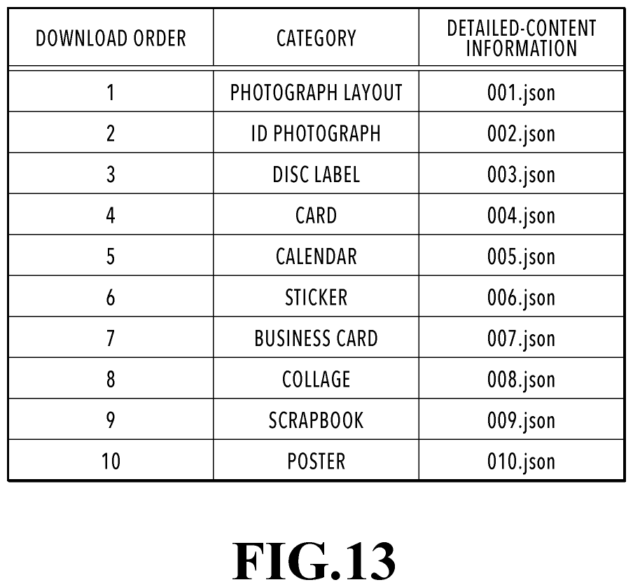

FIG. 13 is a diagram illustrating a table illustrating the content list. As illustrated in FIG. 13, information indicating the download order of the categories (download order information) and information for obtaining the detailed-content information are described in the content list. The information for obtaining the detailed-content information is, for example, a file name of the detailed-content information. Then, the downloading of the pieces of detailed-content information for the respective categories is performed in the order according to the information obtained in S1201 as the background processing. The download order illustrated in FIG. 13 is an order predetermined by a vendor that provides the printing application and that manages the content management server 101. This predetermined order is hereinafter referred to as default order. In the present embodiment, the printing application grasps the default order according to the table of FIG. 13. Accordingly, the default order is, in other words, an order predetermined based on the information provided from the content management server 101. Note that the download order illustrated in FIG. 13 is sometimes changed by processing of S1210 to be described later. Accordingly, the default order is, in other words, an order in a state where the order is unchanged by the processing of S1210. However, even in the case where the order is changed by the processing of S1210, if the downloading of the detailed-content information becomes necessary again, the default order is referred to first in this downloading. Note that a timing at which the table is restored to indicate the default order after the change of the order by the processing of S1210 is not limited to a particular timing. This timing may be, for example, a timing at which determination of YES is made in S1213 to be described later, a timing at which the printing application is closed, or a timing just before S1201. Note that, in the present embodiment, the default order is defined such that a place of a category corresponding to a function more frequently used in the printing application is earlier in the order. Specifically, in the present embodiment, since the function corresponding to the “photograph layout” is most frequently used in the printing application, control is performed such that the detailed-content information corresponding to the “photograph layout” is downloaded first. Note that the table illustrated in FIG. 13 may be information held in advance by the printing application. Specifically, the information processing apparatus 200 may hold the table by installing the printing application. Details of the download processing in background are explained later.

After the start of download processing in background, in S1202, the CPU 211 displays the top screen illustrated in FIG. 6. In S1203, the CPU 211 receives category selection performed by an operation on any of the category selection buttons 607.

In S1204, the CPU 211 determines whether the category selection button is pressed. In the case where no category selection button is pressed, the CPU 211 repeats S1203 and S1204 until the category selection button is pressed. In the case where the category selection button of a specific category among the multiple categories is pressed, the CPU 211 proceeds to S1205, and displays the content selection screen of the selected category.

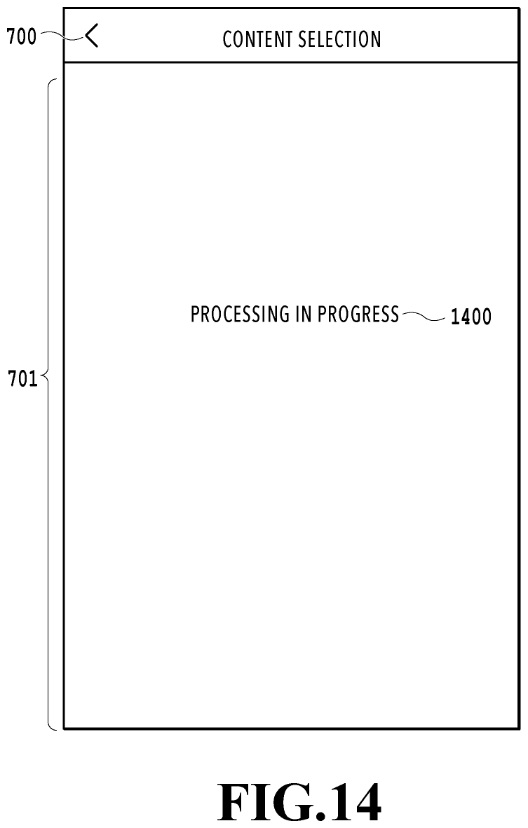

FIG. 14 is a diagram illustrating the content selection screen in a processing-in-progress state. The content selection screen displayed by the CPU 211 at the timing at which the processing proceeds from S1204 to S1205 includes a message 1400 indicating that processing is in progress. This is because the downloading of the detailed-content information for the selected category may not be completed yet. Note that, in the case where the downloading of the selected detailed-content information is completed, a screen in a state where the content information 702 based on the downloaded detailed-content information as illustrated in FIG. 7 may be displayed instead of the content selection screen of the processing-in-progress state illustrated in FIG. 14. Moreover, a form in which the screen of FIG. 14 is not displayed between S1204 and S1205 irrespective of the download status may be adopted.

In S1206, the CPU 211 determines the download status of the detailed-content information for the category corresponding to the category selection button selected in S1204. In the case where the downloading of the detailed-content information for the selected category is completed, the CPU 211 proceeds to S1207, and displays the content information 702 corresponding to the downloaded detailed-content information in the content display region 701 as illustrated in FIG. 7. Then, the CPU 211 terminates the main processing of the present flowchart.

In the case where the detailed-content information for the selected category is being downloaded, the CPU 211 proceeds to S1208, and continues to display the content selection screen illustrated in FIG. 14. In the case where the downloading of the detailed-content information for the selected category is not completed and the detailed-content information for the selected category is not being downloaded, the CPU 211 proceeds to S1209, and continues to display the content selection screen illustrated in FIG. 14. Moreover, after the processing of S1209, the CPU 211 proceeds to S1210, and changes the category to be downloaded next to the category received from the user in S1205. After S1208 and S1210, the CPU 211 returns the processing to S1206.

Specifically, in S1206 to S1210, in the case where the downloading of the detailed-content information selected by the user is not completed or is not performed, the content selection screen of the processing-in-progress state illustrated in FIG. 14 continues to be displayed until the downloading is completed. Then, in the case where the downloading is completed, the downloaded detailed-content information for the category is displayed.

Next, the download processing in background is explained. In S1211, the CPU 211 sets the category of first place as the download target according to the download order in the content list illustrated in FIG. 13. In S1212, the CPU 211 downloads the detailed-content information and the thumbnail image for the category being the download target, from the content management server 101 and the image management server 102. As described above, the detailed-content information includes the print sheet size information, the content name, and the information indicating the saved location of the thumbnail image. Accordingly, specifically, the CPU 211 downloads the detailed-content information, and downloads the thumbnail image by referring to the saved location of the thumbnail image included in the detailed-content information. Moreover, the content information 702 can be displayed on the content selection screen of FIG. 7 by using the downloaded detailed-content information and thumbnail image.

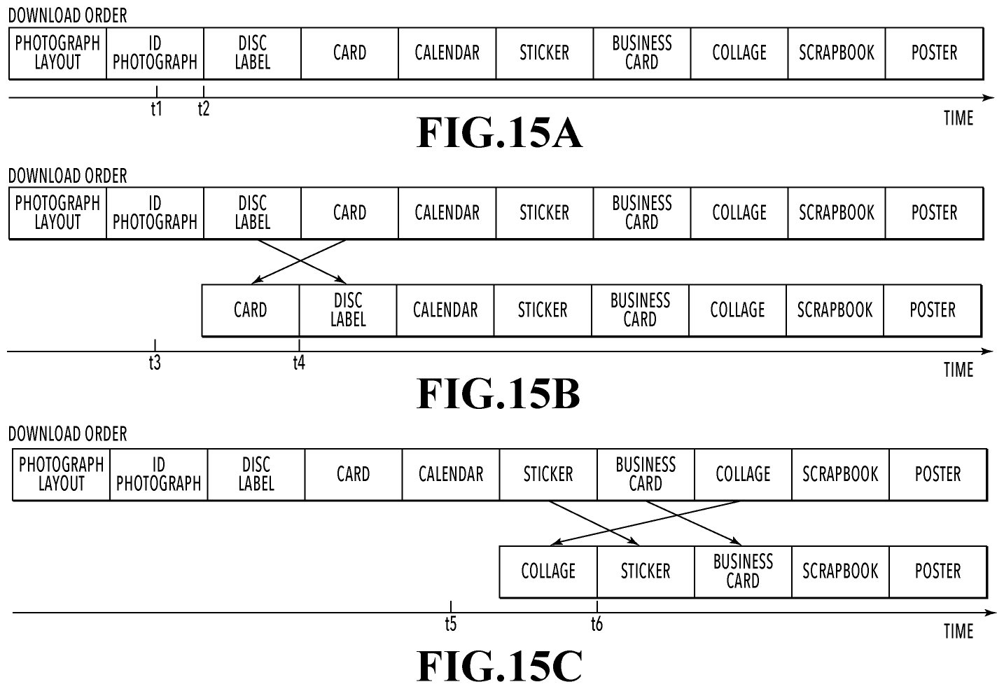

In S1213, the CPU 211 determines whether downloading of the detailed-content information for all categories is completed. In the case where the CPU 211 determines that the downloading for all categories is completed, the CPU 211 terminates the background processing of the present flowchart. Meanwhile, in the case where the downloading of the content detailed information for all categories is not completed, the CPU 211 proceeds to S1214, and specifies the category of the next-highest place. The CPU 211 sets the detailed-content information for the specified category as the download target, and then returns the processing to S1212. Specifically, the CPU 211 repeats the processing until the downloading of the detailed-content information for all categories is completed. Note that, in the case where the processing of S1210 is performed due to selection by the user in the content selection screen during the downloading of S1212, the category specified in S1214 is based on the processing in S1210 in the main processing. Specifically, in the case where the processing of S1210 is performed due to selection by the user in the content selection screen during the downloading in S1212, the category specified in S1214 becomes the category selected by the user in the content selection screen. Details of the download order are explained below by using FIGS. 15A to 15C.

FIGS. 15A to 15C are diagrams illustrating the download order of categories. FIG. 15A illustrates that, at a time point t1, downloading of the detailed-content information for the category of “photograph layout” is completed, and the detailed-content information for the category of “ID photograph” that is the next item is being downloaded. Assume a case where the category selection button of the “photograph layout” is pressed by a user operation at the time point t1. The detailed-content information for the category of “photograph layout” has been already downloaded. Accordingly, the downloaded detailed-content information can be displayed in the content display region 701 of the content selection screen at the timing of the time point t1. Meanwhile, assume a case where the category selection button of the “ID photograph” is pressed at the time point t1. In this case, the detailed-content information for the “ID photograph” is being downloaded. Accordingly, the downloaded content for the “ID photograph” is displayed in the content display region 701 of the content selection screen at a timing of a time point t2 at which the downloading of the detailed-content information for the “ID photograph” is completed. The content selection screen of the processing-in-progress state as illustrated in FIG. 14 is displayed until the time point t2 comes.

Next, FIG. 15B illustrates a diagram in the case where the category selection button is pressed at a time point t3 in the middle of downloading of the detailed-content information for the “ID photograph”. Assume a case where the category selection button of the “card” is pressed at the time point t3. The detailed-content information for the category of “card” is currently in a not-downloaded state. Accordingly, in order to preferentially download the detailed-content information for the card immediately after the detailed-content information for the category of “ID photograph” that is being downloaded, the place of the content detailed information for the “disc label” and the place of the detailed-content information for the “card” in the download order are switched. Then, the downloaded detailed-content information for the “card” is displayed in the content display region 701 of the content selection screen at a timing of a time point t4 at which the downloading of the detailed-content information for the “card” is completed.

FIG. 15C illustrates a diagram in the case where the category selection button is pressed at a time point t5 in the middle of downloading of the detailed-content information for the category of “calendar”. Assume a case where the category selection button of the “collage” is pressed at the time point t5. In this case, since the detailed-content information for the “collage” is in a not-downloaded state, the detailed-content information for the category of “collage” is downloaded immediately after the detailed-content information for the category of “calendar” that is being downloaded. With this change, the download order hereinafter is changed to the order of collage, sticker, and business card. Thereafter, the downloaded detailed-content information for the “collage” is displayed in the content display region 701 of the content selection screen at a timing of a time point t6 at which the downloading of the detailed-content information for the “collage” is completed.

As described above, according to the present embodiment, usability in the downloading of the detailed-content information can be improved. Specifically, downloading the pieces of detailed-content information for the respective categories and preferentially downloading the detailed-content information for the category selected by the user can reduce waiting time it takes for the content of interest for the user to become usable.

In the present embodiment, in the case where the downloading of the detailed-content information for the category selected by the user is not completed, the display screen illustrated in FIG. 14 and indicating the downloading-in-progress state is displayed until the downloading of the detailed-content information for this category is completed. However, the present embodiment is not limited to this form, and may adopt a form in which, in the case where part of the detailed-content information for the selected category is downloaded, the downloaded detailed-content information is displayed on the content selection screen. Moreover, the present embodiment may adopt a form in which the pieces of detailed-content information are displayed sequentially as they are downloaded. Such a form can reduce a state where no detailed-content information is displayed, and the downloaded pieces of detailed-content information can be displayed sequentially to the user.

### Embodiment 2

In Embodiment 1 described above, explanation is given of the form in which the order of categories in downloading of the detailed-content information is determined according to the information on the content list obtained at the launch of the printing application. However, the present disclosure is not limited to this form, and the control of changing the order of categories in downloading may be performed in various conditions.

In the present embodiment, the number of times of printing for each category is recorded in execution of printing by the printing apparatus 300. Then, in S1211 of FIG. 12, the order of downloading the detailed-content information is determined based on the recorded number of times of printing. The category for which the downloading is performed first is the category whose number of times of printing is the largest. Hereinafter, the downloading for the categories is performed in the descending order of the number of times of printing. Moreover, the sheet size may be used to determine the download order, in addition to the number of times of printing.

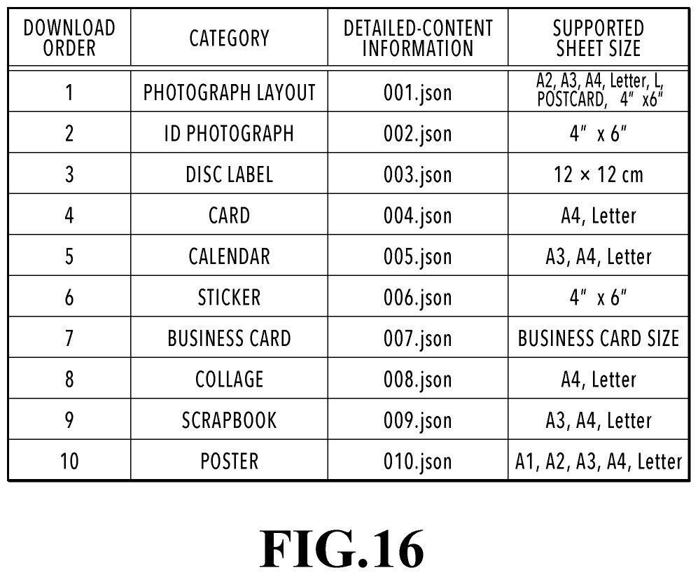

FIG. 16 is information on a content list obtained at the launch of the printing application in the present embodiment. The current download order in FIG. 16 is the same as the order illustrated in FIG. 15A. In this case, the content list includes information on a sheet size supported by each category. The sheet size needs to be set as a print setting for execution of printing by the printing apparatus 300. In the present embodiment, the number of times of printing for each sheet size is recorded. For example, in the case where the number of times of printing in A3 size is the largest, the downloading is performed preferentially for categories supporting A3 size. As a result, the download order becomes the order of photograph layout, calendar, scrapbook, poster, ID photograph, disc label, card, sticker, business card, and collage.

As described above, in the present embodiment, the order of downloading the detailed-content information is determined based on print history information. The detailed-content information for the category considered to be the category of interest for the user is thereby preferentially downloaded. Thus, the waiting time it takes for the content to become usable is reduced, and the usability is improved.

### Embodiment 3

In the above-mentioned embodiment, explanation is given of the form in which the order of categories in downloading of the detailed-content information is determined based on the print history or the information on the content list obtained at the launch of the printing application. However, the present disclosure is not limited to this form.

The top screen of the printing application includes the printer registration button 600, and the printer to execute printing can be registered in advance. The order of downloading the detailed-content information may be determined based on information on a sheet size in which the registered printer can perform printing and information on a sheet size supported by each of the categories included in the content list. For example, in the case where a printer capable of performing printing in sizes of A4 size to A2 size is registered, pieces of detailed-content information for categories printable in these sheet sizes are preferentially downloaded. In the case where the information on the content list obtained at the launch of the printing application is as illustrated in FIG. 16, specifically, the order is set to the order of photograph layout, card, calendar, collage, scrapbook, poster, ID photograph, disc label, sticker, and business card. Moreover, as another example, regarding the disc label, the printing apparatus 300 needs to support disc label printing. Accordingly, in the case where a printer that does not support the disc label printing is registered, downloading of the detailed-content information for the disc label is performed last.

As described above, in the present embodiment, determining the order of categories in downloading of the detailed-content information based on the registered printer information can reduce the waiting time it takes for the content of the category that is likely to be interesting for the user to become usable.

### Other Embodiments

Note that the present disclosure may adopt a form in which the flowchart of FIG. 12 is started every time the application is launched or a form in which the flowchart is not. For example, the present disclosure may adopt a form in which the flowchart is started in response to an operation of a predetermined button for downloading of the detailed-content information by the user after the launch of application. Moreover, in the case where all pieces of detailed-content information have been already downloaded and the printing application holds all pieces of content information, the downloading of the detailed-content information does not have to be performed. Moreover, even in the case where all pieces of detailed-content information have been already downloaded, the printing application may communicate with the content management server 101, and determine whether there is updated content information, at the launch of application. Then, in the case where the printing application determines that there is no updated detailed-content information, the downloading of the detailed-content information does not have to be performed. In the case where the printing application determines that there is updated detailed-content information, the flowchart of FIG. 12 may be started. Note that, in this case, only the updated detailed-content information may be downloaded according to the order illustrated in the table of FIG. 13.

Moreover, the form in which the detailed-content information is downloaded and the contents themselves are not downloaded in the download processing is explained above. However, the present disclosure is not limited to this form, and the contents themselves may also be downloaded in addition to the detailed-content information in the download processing. In this form, since the contents themselves are downloaded in advance in the download processing, the contents themselves do not have to be downloaded after the content selection in the content selection screen.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-090787, filed Jun. 1, 2023, which is hereby incorporated by reference wherein in its entirety.

What is claimed is:

1. A control method of an information processing apparatus, the control method comprising:
downloading information relating to a content of a first category, information relating to a content of a second category, and information relating to a content of a third category to the information processing apparatus in sequence according to a predetermined download order;
displaying a plurality of regions including a region corresponding to the content of the first category, a region corresponding to the content of the second category, and a region corresponding to the content of the third category; and
executing, in a case where one of the plurality of regions is selected, display being based on information that relates to a content of a category corresponding to the selected one region and that is already downloaded to the information processing apparatus, wherein
a place of the information relating to the content of the first category in the predetermined download order is a first place, a place of the information relating to the content of the second category in the predetermined download order is a second place that is after the first place, and a place of the information relating to the content of the third category in the predetermined download order is a third place that is after the first place and the second place,
in a case where the region corresponding to the content of the third category is selected in a state where the information relating to the content of the first category is being downloaded and downloading of the information relating to the content of the second category and the information relating to the content of the third category is not completed yet, control is performed such that the downloading of the information relating to the content of the third category is executed before the downloading of the information relating to the content of the second category, and
in a case where the region corresponding to the content of the third category is not selected in the state where the information relating to the content of the first category is being downloaded and the downloading of the information relating to the content of the second category and the information relating to the content of the third category is not completed yet, control is performed such that the downloading of the information relating to the content of the second category is executed before the downloading of the information relating to the content of the third category.

2. The control method according to claim 1, wherein
downloading of information whose place in the predetermined download order is the first place starts based on launch of a program.

3. The control method according to claim 1, further comprising specifying the predetermined download order based on order information indicating the predetermined download order, wherein
the information relating to the content of the first category, the information relating to the content of the second category, and the information relating to the content of the third category are downloaded to the information processing apparatus in sequence according to the specified predetermined download order.

4. The control method according to claim 3, wherein the order information is obtained from a predetermined server outside the information processing apparatus.

5. The control method according to claim 4, wherein the predetermined server that provides the order information to the information processing apparatus is a server that causes the information processing apparatus to download the plurality of contents.

6. The control method according to claim 3, wherein the order information is obtained based on launch of a program.

7. The control method according to claim 3, wherein the order information is information held in advance by a program.

8. The control method according to claim 1, wherein the plurality of regions are displayed on a top screen of a program displayed based on launch of the program.

9. The control method according to claim 1, wherein
in the case where the region corresponding to the content of the third category is selected in the state where the information relating to the content of the first category is being downloaded and the downloading of the information relating to the content of the second category and the information relating to the content of the third category is not completed yet, a screen corresponding to non-completion of the downloading of the information relating to the content of the third category is displayed, and
in a case where the downloading of the information relating to the content of the third category is completed after the display of the screen corresponding to non-completion of the downloading of the information relating to the content of the third category, display based on the information relating to the content of the third category is executed.

10. The control method according to claim 9, wherein, in the case where the region corresponding to the content of the third category is selected in a state where the downloading of the information relating to the content of the third category is completed, the display based on the information relating to the content of the third category is executed without the display of the screen corresponding to non-completion of the downloading of the information relating to the content of the third category.

11. The control method according to claim 1, wherein
the information relating to the content of the third category includes a thumbnail image corresponding to the content of the third category, and
display based on the information relating to the content of the third category is display of the thumbnail image corresponding to the content of the third category.

12. The control method according to claim 11, wherein
the content of the third category includes a plurality of contents, and
the display based on the information relating to the content of the third category is display of a plurality of thumbnail images corresponding, respectively, to the plurality of contents included in the content of the third category.

13. The control method according to claim 12, further comprising downloading, after selection of one of the plurality of thumbnail images, a content corresponding to the selected thumbnail image to the information processing apparatus.

14. The control method according to claim 13, wherein the information relating to the content of the third category includes information for downloading the content of the third category to the information processing apparatus.

15. The control method according to claim 13, further comprising:
displaying, after the selection of one of the plurality of thumbnail images, a print setting screen based on the content that corresponds to the selected thumbnail image and that is downloaded to the information processing apparatus; and
after display of the print setting screen, sending a print job that causes a printing apparatus to perform printing based on the content corresponding to the selected thumbnail image, to the printing apparatus.

16. The control method according to claim 14, wherein
after the selection of one of the plurality of thumbnail images, print setting information for printing the content corresponding to the selected thumbnail image is further downloaded, and
the print setting screen is displayed based also on the print setting information.

17. The control method according to claim 1, wherein the predetermined download order is controlled such that information relating to a content of a category corresponding to a function more frequently used in a program is downloaded earlier.

18. The control method according to claim 1, wherein the contents of the plurality of categories include contents of at least one of categories of photograph layout, ID photograph, disc label, card, calendar, sticker, business card, collage, scrapbook, and poster.

19. An information processing apparatus comprising:
a download unit configured to download information relating to a content of a first category, information relating to a content of a second category, and information relating to a content of a third category to the information processing apparatus in sequence according to a predetermined download order;
a display control unit configured to display a plurality of regions including a region corresponding to the content of the first category, a region corresponding to the content of the second category, and a region corresponding to the content of the third category; and
a execute unit configured to execute, in a case where one of the plurality of regions is selected, display being based on information that relates to a content of a category corresponding to the selected one region and that is already downloaded to the information processing apparatus, wherein
a place of the information relating to the content of the first category in the predetermined download order is a first place, a place of the information relating to the content of the second category in the predetermined download order is a second place that is after the first place, and a place of the information relating to the content of the third category in the predetermined download order is a third place that is after the first place and the second place,
in a case where the region corresponding to the content of the third category is selected in a state where the information relating to the content of the first category is being downloaded and downloading of the information relating to the content of the second category and the information relating to the content of the third category is not completed yet, control is performed such that the downloading of the information relating to the content of the third category is executed before the downloading of the information relating to the content of the second category, and
in a case where the region corresponding to the content of the third category is not selected in the state where the information relating to the content of the first category is being downloaded and the downloading of the information relating to the content of the second category and the information relating to the content of the third category is not completed yet, control is performed such that the downloading of the information relating to the content of the second category is executed before the downloading of the information relating to the content of the third category.

20. A non-transitory computer readable storage medium storing a program which functions in an information processing apparatus and causes the information processing apparatus to execute:
downloading information relating to a content of a first category, information relating to a content of a second category, and information relating to a content of a third category to the information processing apparatus in sequence according to a predetermined download order;
displaying a plurality of regions including a region corresponding to the content of the first category, a region corresponding to the content of the second category, and a region corresponding to the content of the third category; and
executing, in a case where one of the plurality of regions is selected, display being based on information that relates to a content of a category corresponding to the selected one region and that is already downloaded to the information processing apparatus, wherein
a place of the information relating to the content of the first category in the predetermined download order is a first place, a place of the information relating to the content of the second category in the predetermined download order is a second place that is after the first place, and a place of the information relating to the content of the third category in the predetermined download order is a third place that is after the first place and the second place,
in a case where the region corresponding to the content of the third category is selected in a state where the information relating to the content of the first category is being downloaded and downloading of the information relating to the content of the second category and the information relating to the content of the third category is not completed yet, control is performed such that the downloading of the information relating to the content of the third category is executed before the downloading of the information relating to the content of the second category, and
in a case where the region corresponding to the content of the third category is not selected in the state where the information relating to the content of the first category is being downloaded and the downloading of the information relating to the content of the second category and the information relating to the content of the third category is not completed yet, control is performed such that the downloading of the information relating to the content of the second category is executed before the downloading of the information relating to the content of the third category.
